(19) United States
(12) Patent Application Publication
(10) Pub. No.: US 2025/0296031 A1
(43) Pub. Date: Sep. 25, 2025

(54) CARBON DIOXIDE RECOVERY APPARATUS

(71) Applicant: HONDA MOTOR CO., LTD., Tokyo (JP)

(72) Inventors: Hibiki KIMURA, Saitama (JP); Subaru MATSUMOTO, Saitama (JP); Masanobu TAKAZAWA, Saitama (JP); Ryo NINOMIYA, Saitama (JP)

(21) Appl. No.: 19/064,758

(22) Filed: Feb. 27, 2025

(30) Foreign Application Priority Data
Mar. 22, 2024 (JP) 2024-047179

(51) Int. Cl. B01D 53/04; B01D 53/047; B01D 53/62; B01D 53/96

(52) U.S. Cl. CPC B01D 53/0462; B01D 53/0438; B01D 53/0476; B01D 53/62; B01D 53/96; B01D 2257/504; B01D 2259/40007

(57) ABSTRACT

A carbon dioxide recovery apparatus includes: a bypass line that is capable of introducing a heat medium that has passed through a first module into a second module 11b differing from the first module; an upstream-side four-way valve and a downstream-side four-way valve that are disposed for each of the modules, and that are capable of switching between a hot water line, a cold water line, and a bypass line for a passage through which the heat medium is to be supplied to the module, and adjusting the flow rate of the heat medium to pass through the module; and a control device that changes, in accordance with the state of an adsorbent by controlling the upstream-side four-way valve and the downstream-side four-way valve, switching control for switching the passage for the heat medium and flow rate control for adjusting the flow rate of the heat medium.

This application is based on and claims the benefit of priority from Japanese Patent Application No. 2024-047179, filed on 22 Mar. 2024, the content of which is incorporated herein by reference.

### BACKGROUND OF THE INVENTION

### Field of the Invention

The present invention relates to a carbon dioxide recovery apparatus.

### Related Art

Techniques for capturing carbon dioxide from a gas containing carbon dioxide, such as from atmospheric air, have been conventionally known. For example, Japanese Unexamined Patent Application (Translation of PCT Application), Publication No. 2017-528318 describes such a type of technique. Japanese Unexamined Patent Application (Translation of PCT Application), Publication No. 2017-528318 describes a method for separating gaseous carbon dioxide from a gas mixture by cyclic adsorption/desorption using an adsorbent adsorbing said gaseous carbon dioxide.

Patent Document 1: Japanese Unexamined Patent Application (Translation of PCT Application), Publication No. 2017-528318

### SUMMARY OF THE INVENTION

In a carbon dioxide recovery apparatus that performs a desorption process and an adsorption process concurrently in parallel by using a plurality of modules each having an adsorbent, the absorbent of a first module may be cooled by a heat medium for cooling, and the temperature of the absorbent of a second module may be increased by a heat medium for heating. In order to enhance the energy efficiency, exhaust heat may be recovered from the first module, and the recovered heat may be used so as to increase the temperature of the adsorbent of the second module.

Performing only the exhaust heat recovery from the first module may be insufficient to increase the temperature of the adsorbent of the second module to a temperature at which desorption can occur. Heat media to be used may be switched between temperature increasing steps, but the necessary and sufficient flow rate of the heat medium to flow through the modules varies according to the temperature potential of the heat medium to be used or according to the steps in the desorption process and the adsorption process. Thus, if the heat medium circulates at a certain flow rate without the state of the adsorbent or the temperature potential of the heat medium supplied to the modules being considered, the temperature of the adsorbent may be increased or decreased beyond necessity. In the meantime, since the flow rate is directly associated with the workload on a pump, the flow rate of the heat medium is preferably set to a minimally necessary level. It has been desired to make carbon dioxide recovery apparatus energy-saving, and the prior art has had problems with suppressing the power consumption of a pump for circulating a heat medium.

An object of the present invention is to provide a carbon dioxide recovery apparatus that can accurately increase or decrease the temperature in a desorption process and an adsorption process by using a heat medium at a proper flow rate and that can achieve energy saving.

(1) The present invention provides a carbon dioxide recovery apparatus (e.g., carbon dioxide recovery apparatus 1 described hereinafter) including: a plurality of modules (e.g., modules 11 described hereinafter) that each have an adsorbent (e.g., adsorbent 12 described hereinafter) therein and perform an adsorption process in which a gas containing carbon dioxide is suctioned to the adsorbent such that the adsorbent adsorbs the carbon dioxide and a desorption process in which the carbon dioxide is desorbed from the adsorbent by heating the surroundings of the adsorbent with the surroundings being decompressed; an adapted-for-heating heat medium line (e.g., hot water line 112 described hereinafter) for supplying, to each of the plurality of modules, a relatively high-temperature heat medium (e.g., hot water described hereinafter) so as to heat the adsorbent for performing the desorption process; an adapted-for-cooling heat medium line (e.g., cold water line 111 described hereinafter) for supplying, to each of the plurality of modules, a relatively low-temperature heat medium (e.g., cold water described hereinafter) so as to cool the adsorbent for performing the adsorption process; a heat source device (e.g., heat source device 81 described hereinafter) that is capable of heating the heat medium flowing through the adapted-for-heating heat medium line, and cooling the heat medium flowing through the adapted-for-cooling heat medium line; a bypass line (e.g., bypass line 31 described hereinafter) that is capable of introducing the heat medium that has passed through a first module, which is one of the plurality of modules, into a second module differing from the first module; a flow rate adjuster (e.g., upstream-side four-way valve 30a and downstream-side four-way valve 30b described hereinafter) that is disposed for each of the modules, and that is capable of switching between the adapted-for-heating heat medium line, the adapted-for-cooling heat medium line, and the bypass line for a passage through which the heat medium is to be supplied to the module, and adjusting the flow rate of the heat medium to pass through the module; and a control device (e.g., control device 90 described hereinafter) that changes, in accordance with the state of the adsorbent by controlling the flow rate adjuster, switching control for switching the passage for the heat medium and flow rate control for adjusting the flow rate of the heat medium.

(2) In the carbon dioxide recovery apparatus according to aspect (1), the flow rate adjuster may be formed from an upstream-side four-way valve (e.g., upstream-side four-way valve 30a described hereinafter) connected to the upstream side of the module and having the adapted-for-heating heat medium line, the adapted-for-cooling heat medium line, and the bypass line connected thereto, and a downstream-side four-way valve (e.g., downstream-side four-way valve 30b described hereinafter) connected to the downstream side of the module and having the adapted-for-heating heat medium line, the adapted-for-cooling heat medium line, and the bypass line connected thereto, and by switching internal flow passages of the upstream-side four-way valve and the downstream-side four-way valve, the control device may switch the passage for the heat medium to be supplied to the module.

(3) In the carbon dioxide recovery apparatus according to aspect (1) or (2), the control device may perform the flow rate control such that, in comparison with the flow rate in a temperature increasing step of increasing the temperature of the adsorbent to a prescribed temperature in the desorption process by means of the heat medium supplied from the adapted-for-heating heat medium line, the flow rate is low in a maintenance step of maintaining, at the prescribed temperature, the adsorbent that has reached the prescribed temperature as a result of the temperature increase.

(4) In the carbon dioxide recovery apparatus according to aspect (1) or (2), the control device may perform, after the desorption process is performed, bypass control for cooling the adsorbent of the first module by using the heat medium supplied from the adapted-for-cooling heat medium line, and increasing the temperature of the second module by supplying the heat medium that has cooled the first module to the second module through the bypass line.

(5) In the carbon dioxide recovery apparatus according to aspect (4), the control device may perform, after performing the bypass control, control for making the flow rate of the heat medium supplied from the adapted-for-cooling heat medium line to the first module higher than in the bypass control.

(6) In the carbon dioxide recovery apparatus according to aspect (4), after performing the bypass control, the control device may close the passage from the bypass line to the second module, and supply the heat medium from the adapted-for-heating heat medium line to the second module at a flow rate that is higher than the flow rate at which the heat medium was supplied to the second module in the bypass control.

The present invention can provide a carbon dioxide recovery apparatus that can accurately increase or decrease the temperature in a desorption process and an adsorption process by using a heat medium at a proper flow rate and that can achieve energy saving.

### BRIEF DESCRIPTION OF THE DRAWINGS

FIG. 1 is a schematic diagram illustrating configurations pertaining to gas flows in a carbon dioxide recovery apparatus according to one embodiment of the present invention;

FIG. 2 is a schematic diagram illustrating configurations pertaining to gas flows in a module of a carbon dioxide recovery apparatus according to present embodiments;

FIG. 3 is a schematic diagram illustrating the configuration of the heat exchange device of a carbon dioxide recovery apparatus according to present embodiments;

FIG. 4 is a graph indicating the relationship between the temperature of the adsorbent of a first module and the rate of supply of a heat medium;

FIG. 5 is a graph indicating the relationship between the temperature of the adsorbent of a second module and the rate of supply of a heat medium;

FIG. 6 is a schematic diagram illustrating the connection state of the flow passages of the first module and the second module in a first step;

FIG. 7 is a schematic diagram illustrating the connection state of the flow passages of the first module and the second module in a second step; and

FIG. 8 is a schematic diagram illustrating the connection state of the flow passages of the first module and the second module in a third step.

### DETAILED DESCRIPTION OF THE INVENTION

The following describes embodiments of the present invention by referring to the drawings.

### Configurations Pertaining to Gas Flows

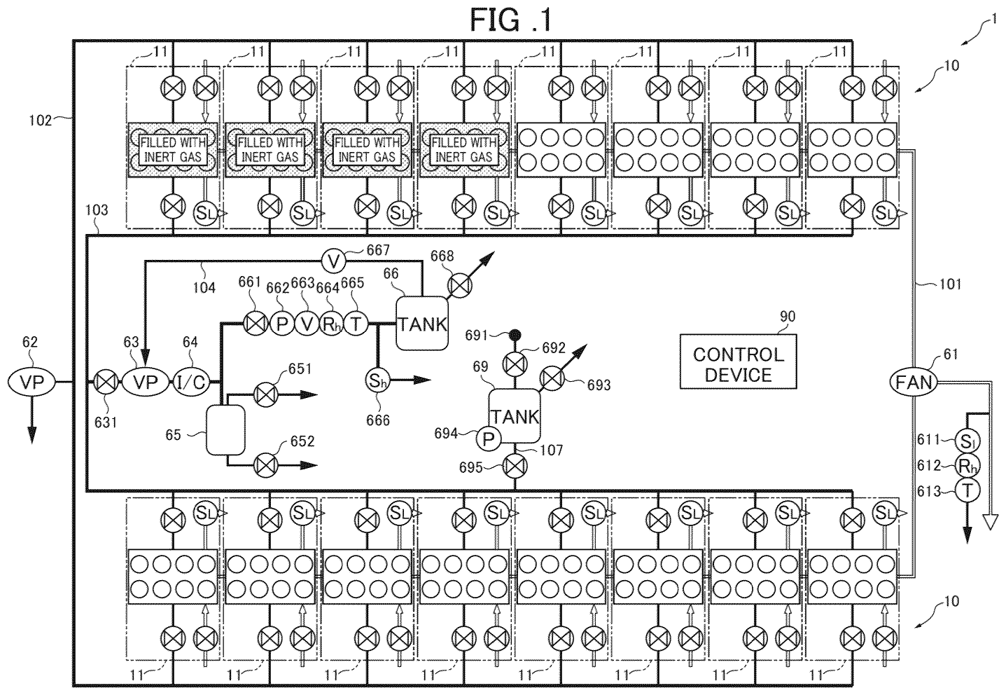

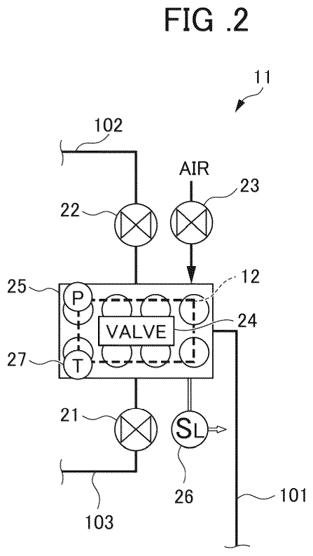

First, descriptions are given of configurations for capturing carbon dioxide from atmospheric air by referring to FIGS. 1 and 2. FIG. 1 is a schematic diagram illustrating configurations pertaining to gas flows in a carbon dioxide recovery apparatus 1 according to one embodiment of the present invention. FIG. 2 is a schematic diagram illustrating configurations pertaining to gas flows in a module 11 of the carbon dioxide recovery apparatus 1 according to present embodiments.

For example, the carbon dioxide recovery apparatus 1 according to present embodiments is applied to direct air capture (DAC) technologies for capturing the carbon dioxide in atmospheric air in order to reduce the carbon dioxide concentration of atmospheric air. Carbon dioxide captured by the carbon dioxide recovery apparatus 1 is stored in the ground or reused as a fuel or a material.

As depicted in FIG. 1, the carbon dioxide recovery apparatus 1 according to present embodiments includes module units 10, a fan 61, a vacuum pump 62, a carbon dioxide capture pump 63, an intercooler 64, a separator 65, a carbon dioxide tank 66, and an inert gas tank 69. The carbon dioxide recovery apparatus 1 also includes an adsorption line 101, a vacuum line 102, a carbon dioxide line 103, a circulation line 104, and an inert gas supply line 107 as gas flow passages. Note that FIGS. 1 and 2 do not depict a heat exchange device 70 that supplies heat to, and recovers exhaust heat from, the modules 11.

The module units 10 are configured such that a plurality of modules 11 that adsorb carbon dioxide are arranged in parallel. In present embodiments, a total of 16 modules 11 are disposed in one pair of left and right module units 10.

As depicted in FIG. 2, the module 11 is a carbon dioxide capture module that is provided with an adsorbent 12, a first valve 21, a second valve 22, a third valve 23, a fourth valve 24, a pressure sensor 25, a carbon dioxide sensor 26, and a temperature sensor 27.

The adsorbent 12 is disposed in the module 11 in order to adsorb carbon dioxide. The adsorbent 12 is a particulate member and has the property of adsorbing carbon dioxide while in a low temperature state (e.g., range from −30° C. to 50° C.) and desorbing (releasing) carbon dioxide while in a high temperature state (e.g., range from 50° C. to 110° C.) with a low ambient carbon dioxide concentration. For example, the adsorbent 12 may be a carbon dioxide adsorbent of solid amine that is formed from a porous material of, for example, silica carrying an amine.

The first valve 21 is a switching valve disposed at a portion of connection between the carbon dioxide line 103, which captures carbon dioxide, and the module 11. The carbon dioxide capture pump 63 is disposed on the carbon dioxide line 103. The second valve 22 is a switching valve disposed at a portion of connection between the vacuum line 102, on which the vacuum pump 62 is disposed, and the module 11. The third valve 23 is a switching valve disposed at an inlet through which atmospheric air and the like enter the module 11. The fourth valve 24 is a switching valve disposed at a portion of connection between the adsorption line 101 and the module 11.

The first valve 21, the second valve 22, the third valve 23, and the fourth valve 24 are all subjected to open/close control performed by the control device 90. For example, the first valve 21, the second valve 22, the third valve 23, and the fourth valve 24 are formed from normally open butterfly valves.

The pressure sensor 25 measures the internal pressure of the module 11. The carbon dioxide sensor 26 measures the carbon dioxide concentration of the inside of the module 11. The temperature sensor 27 measures the temperature of the adsorbent 12. Measurement information pertaining to the pressure sensor 25, the carbon dioxide sensor 26, and the temperature sensor 27 is transmitted to the control device 90.

Descriptions are given of the adsorption line 101 and the fan 61 by referring to FIG. 1 again. The adsorption line 101 is branched so as to be connected to the modules 11. The fan 61 is disposed at a portion where branched portions of the adsorption line 101 are merged. The fan 61 is driven so as to produce gas flows of “suction” to “discharge” in the modules 11 through the adsorption line 101. As a result, atmospheric air is supplied into the modules 11. A carbon dioxide concentration sensor 611, a humidity sensor 612, and a temperature sensor 613 are disposed at portions of the adsorption line 101 from which a gas is discharged, and the humidity and the temperature of carbon dioxide discharged from the adsorption line 101 are measured. Measurement information pertaining to the carbon dioxide concentration sensor 611, the humidity sensor 612, and the temperature sensor 613 is transmitted to the control device 90.

The vacuum line 102 is branched so as to be connected to the modules 11. The vacuum pump 62 is disposed at a portion where branched portions of the vacuum line 102 are merged. The vacuum pump 62 is driven so as to suction the gas in the modules 11 through the vacuum line 102 such that the insides of the modules 11 are put in, or brought close to, a vacuum state.

The carbon dioxide line 103 is branched so as to be connected to the modules 11. The carbon dioxide capture pump 63, the intercooler 64, the separator 65, and the carbon dioxide tank 66 are disposed at portions where branched portions of the carbon dioxide line 103 are merged.

The carbon dioxide capture pump 63 produces a suction force for sending carbon dioxide circulating through the carbon dioxide line 103 to the carbon dioxide tank 66. A one-way valve 631 is disposed on the carbon dioxide line 103 at the upstream side of the carbon dioxide capture pump 63. As a result, backflow of a gas from the intercooler 64 side to the module 11 side is prevented.

The intercooler 64 is an intermediate cooling machine that implements gas-liquid separation by cooling a high temperature gas containing carbon dioxide captured from the modules 11.

The separator 65 recovers water obtained as a result of the gas-liquid separation implemented by the intercooler 64. A first valve 651 and a second valve 652 are disposed for the separator 65. The first valve 651 opens/closes a passage in communication with a gas phase section of the separator 65. The second valve 652 opens/closes a passage in communication with a liquid phase section of the separator 65.

The carbon dioxide tank 66 stores carbon dioxide captured through the carbon dioxide line 103. A tank valve 661 is disposed on the carbon dioxide line 103 at the upstream side of the carbon dioxide tank 66. The tank valve 661 is subjected to open/close control performed by the control device 90. Various types of sensors such as a pressure sensor 662, a flow rate sensor 663, a humidity sensor 664, a temperature sensor 665, and a carbon dioxide concentration sensor 666 are disposed on the carbon dioxide line 103 at positions between the tank valve 661 and the carbon dioxide tank 66.

In addition to the carbon dioxide line 103, the carbon dioxide tank 66 has connected thereto the circulation line 104, through which ballast returns to the carbon dioxide capture pump 63. A flow rate sensor 667 is disposed on the circulation line 104. A pressure release valve 668 for releasing a prescribed pressure or higher is disposed for the carbon dioxide tank 66.

Next, descriptions are given of the inert gas tank 69. The inert gas tank 69 stores N₂, which is an inert gas supplied from an N₂ gas cylinder 691, at a certain pressure or higher (e.g., 980 kPa). A gas cylinder valve 692 is disposed between the inert gas tank 69 and the N₂ gas cylinder 691. A pressure release valve 693 for releasing a prescribed pressure or higher is disposed for the inert gas tank 69. A pressure sensor 694 is disposed in the inert gas tank 69. Pressure information obtained through measurement by the pressure sensor 694 is transmitted to the control device 90.

The inert gas tank 69 is connected to the carbon dioxide line 103 via the inert gas supply line 107. An inert gas valve 695 is disposed on the inert gas supply line 107. The inert gas valve 695 is subjected to open/close control performed by the control device 90.

### Configuration of Heat Exchange Device

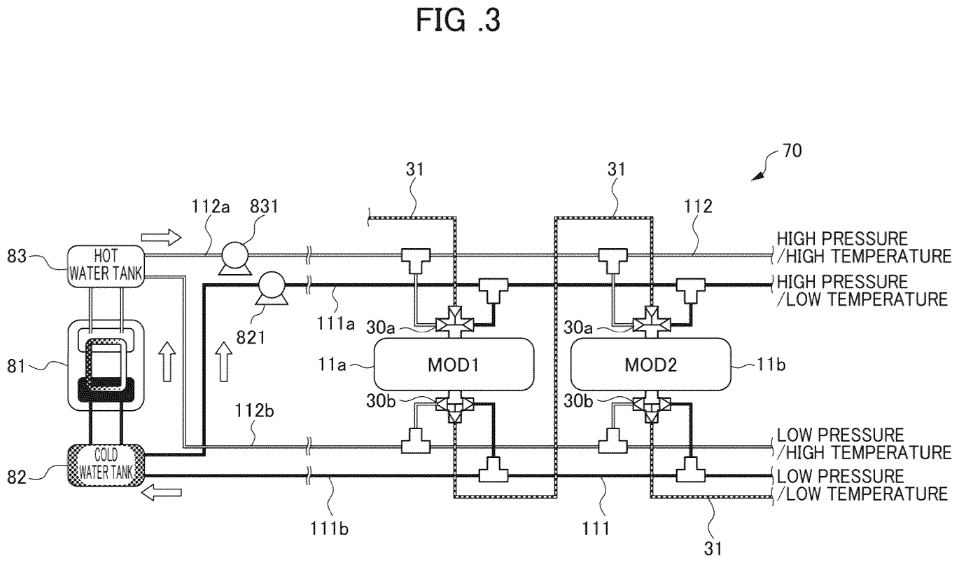

The following describes the configuration of the heat exchange device 70 by referring to FIG. 3. FIG. 3 is a schematic diagram illustrating the configuration of the heat exchange device 70 of the carbon dioxide recovery apparatus 1 according to present embodiments. FIG. 3 depicts a first module 11a and a second module 11b, from among the plurality of modules 11, that the heat exchange device 70 supplies heat to or recovers exhaust heat from. In the following descriptions, the first module 11a and the second module 11b may both be referred to as the modules 11 (alphabets may be omitted) when describing common configurations between the two modules.

When the module units 11 of the module units 10 perform the desorption process, the heat exchange device 70 supplies thermal energy for heating the insides of the modules 11 to a prescribed temperature. When the modules 11 perform the adsorption process, the heat exchange device 70 recovers unnecessary thermal energy.

The heat exchange device 70 according to present embodiments is provided with a cold water line 111, a cold water-circulating water pump 821, a hot water line 112, a hot water-circulating water pump 831, a heat source device 81, a cold water tank 82, a hot water tank 83, upstream-side four-way valves 30a, downstream-side four-way valves 30b, and bypass lines 31.

The cold water line 111 is a pipe through which cold water at a low temperature circulates as an adapted-for-cooling heat medium. The cold water line 111 is branched so as to be connected to the upstream side and the downstream side of each of the modules 11, and connects the cold water tank 82 and each of the modules 11 to each other. A line of the cold water line 111 that is connected to the upstream side of each of the modules 11 is referred to as a going cold water line 111a, and a line thereof that is connected to the downstream side of each of the modules 11 is referred to as a returning cold water line 111b.

The going cold water line 111a is connected in parallel to the plurality of modules 11 and can supply cold water to the modules 11 in parallel. Cold water flowing into the module 11 from the going cold water line 111a is yet to pass through the module 11 and thus serves as a heat medium having a relatively high pressure. The returning cold water line 111b is also connected in parallel to the plurality of modules 11 and can recover the cold water after the completion of cooling from the modules 11 in parallel. Cold water flowing out of the module 11 into the returning cold water line 111b has passed through the module 11 and thus serves as a heat medium having a relatively low pressure.

The cold water-circulating water pump 821 is disposed on the cold water line 111. For example, the cold water-circulating water pump 821 is a cascade pump. The cold water-circulating water pump 821 causes cold water to circulate through the cold water line 111.

The hot water line 112 is a pipe through which hot water at a high temperature circulates as an adapted-for-heating heat medium. The hot water line 112 is branched so as to be connected to the upstream side and the downstream side of each of the modules 11, and connects the hot water tank 83 and each of the modules 11 to each other. A line of the hot water line 112 that is connected to the upstream side of each of the modules 11 is referred to as a going hot water line 112a, and a line thereof that is connected to the downstream side of each of the modules 11 is referred to as a returning hot water line 112b.

The going hot water line 112a is connected in parallel to the plurality of modules 11 and can supply hot water to the modules 11 in parallel. Hot water flowing into the module 11 from the going hot water line 112a is yet to pass through the module 11 and thus serves as a heat medium having a relatively high temperature and a relatively high pressure. The returning hot water line 112b is also connected in parallel to the plurality of modules 11 and can recover the hot water after the completion of heating from the modules 11 in parallel. Hot water flowing out of the module 11 into the returning hot water line 112b has passed through the module 11 and thus serves as a heat medium having a relatively low pressure.

The hot water-circulating water pump 831 is disposed on the hot water line 112. For example, the hot water-circulating water pump 831 is a cascade pump. The hot water-circulating water pump 831 causes hot water to circulate through the hot water line 112.

The heat source device 81 cools the heat medium introduced from the cold water tank 82 and heats the medium introduced from the hot water tank 83. The heat source device 81 is formed from a heat pump that provides a heat transfer by means of gas compression and expansion.

The cold water tank 82 stores cold water that flows through the cold water line 111. The cold water that flows through the cold water line 111 is stored in the cold water tank 82 and then sent to the heat source device 81. The cold water cooled by the heat source device 81 is returned to the cold water tank 82 and then sent to the modules 11 through the cold water line 111.

The hot water tank 83 stores hot water that flows through the hot water line 112. The hot water that flows through the hot water line 112 is stored in the hot water tank 83 and then sent to the heat source device 81. The heat medium heated by the heat source device 81 is returned to the hot water tank 83 and then sent to the modules 11 through the hot water line 112.

The upstream-side four-way valves 30a are flow passage switching devices disposed on the upstream sides of the respective modules 11. The upstream-side four-way valves 30a have a flow rate adjustment function for adjusting the flow rate of a fluid flowing therethrough. The going cold water line 111a, the going hot water line 112a, and the bypass line 31 are connected to the upstream-side four-way valves 30a.

The upstream-side four-way valve 30a in present embodiments has an internal flow passage that can be switched between a cold-water connection state in which the going cold water line 111a and the module 11 are connected, a hot-water connection state in which the going hot water line 112a and the module 11 are connected, and a bypass connection state in which the bypass line 31 and the module 11 are connected.

The downstream-side four-way valves 30b are flow passage switching devices disposed on the downstream sides of the respective modules 11. The downstream-side four-way valves 30b have a flow rate adjustment function for adjusting the flow rate of a fluid flowing therethrough. The returning cold water line 111b, the returning hot water line 112b, and the bypass line 31 are connected to the downstream-side four-way valves 30b.

The downstream-side four-way valve 30b in present embodiments has an internal flow passage that can be switched between a cold-water connection state in which the returning cold water line 111b and the module 11 are connected, a hot-water connection state in which the returning hot water line 112b and the module 11 are connected, and a bypass connection state in which the bypass line 31 and the module 11 are connected.

The bypass lines 31 are each a flow passage that allows the heat medium to move between modules 11. The bypass lines 31 each connect between two modules 11. The bypass lines 31 may each connect adjacent modules 11 to each other or may each connect nonadjacent and distant modules 11 to each other. In the example of FIG. 3, the end portion of a bypass line 31 on one side is connected to the downstream-side four-way valve 30b of the first module 11a, and the end portion thereof on the other side is connected to the upstream-side four-way valve 30a of the second module 11b.

A bypass line 31 connected to the upstream-side four-way valve 30a of the first module 11a is connected to the downstream-side four-way valve 30b of an unillustrated module 11 located on the left-hand side of the figure. A bypass line 31 connected to the downstream-side four-way valve 30b of the second module 11b is connected to the upstream-side four-way valve 30a of an unillustrated module 11 located on the right-hand side of the figure.

The control device 90 controls flow passage switching for the upstream-side four-way valves 30a and the downstream-side four-way valves 30b. When hot water circulates through the module 11, the upstream-side four-way valve 30a connects the going hot water line 112a and the upstream side of the module 11, and the downstream-side four-way valve 30b connects the returning hot water line 112b and the downstream side of the module 11. When cold water circulates through the module 11, the upstream-side four-way valve 30a connects the going cold water line 111a and the upstream side of the module 11, and the downstream-side four-way valve 30b connects the returning cold water line 111b and the downstream side of the module 11.

During the bypass connection state, the downstream-side four-way valve 30b of the first module 11a and the upstream-side four-way valve 30a of the second module 11b connect the downstream side of the first module 11a and the upstream side of the second module 11b via the bypass line 31. As a result, a heat medium (hot water or cold water) that has passed through the first module 11a can circulate to the second module 11b via the bypass line 31.

Next, descriptions are given of the control device 90. The control device 90 controls the operations of components of the carbon dioxide recovery apparatus 1. The control device 90 controls operations such as the driving or stopping of devices used to adsorb or desorb carbon dioxide. In order to allow the plurality of modules 11 to temporally repeat adsorption and desorption, the control device 90 selectively controls timings at which the heat medium is supplied to heat or cool the modules 11.

The control device 90 performs open/close control for the first valve 21, second valve 22, third valve 23, and fourth valve 24 provided for each of the modules 11, and performs open/close control for the upstream-side four-way valve 30a and the downstream-side four-way valve 30b. The control device 90 also performs drive control for, for example, the fan 61, the vacuum pump 62, the carbon dioxide capture pump 63, the cold water-circulating water pump 821, and the hot water-circulating water pump 831.

The control device 90 is a computer that has, for example, a central processing unit (CPU), a read only memory (ROM), and a random access memory (RAM). The control device 90 may be formed from one component or from a plurality of components. The control device 90 may be formed using an electric circuit such as a relay.

### Capturing of Carbon Dioxide

Next, descriptions are given of control performed to capture carbon dioxide by the control device 90. The carbon dioxide recovery apparatus 1 performs, in an alternating pattern, the adsorption process, in which the adsorbent 12 in the module 11 adsorbs carbon dioxide in a suctioned gas such as atmospheric air, and the desorption process, in which the carbon dioxide adsorbed by the adsorbent 12 is desorbed, and compresses and stores the desorbed carbon dioxide in a tank (not illustrated), i.e., removes and captures carbon dioxide from air. In present embodiments, the adsorption process and the desorption process are performed such that the ratio between the time taken for the adsorption process and the time taken for the desorption process is 3:1.

In the adsorption process, the adsorbent 12 in the module 11 adsorbs carbon dioxide. In the adsorption process, the third valve 23 and the fourth valve 24 of the module 11 are open, and the first valve 21 and the second valve 22 thereof are closed. The fan 61 is driven and thus generates a gas flow from upstream to downstream, and a gas (e.g., atmospheric air) containing carbon dioxide is suctioned through the third valve 23. The suctioned gas passes through the adsorbent 12 in the module 11. In this situation, the inside of the module 11 is at an ordinary temperature (25° C.), and the carbon dioxide in the gas is adsorbed by the adsorbent 12. Gases other than carbon dioxide, e.g., nitrogen and oxygen, pass through the fourth valve 24 and the adsorption line 101 and are discharged to the outside of the carbon dioxide recovery apparatus 1.

In the desorption process, the carbon dioxide in/on the adsorbent 12 in the module 11 is desorbed. In the desorption process, the first valve 21, the third valve 23, and the fourth valve 24 of the module 11 are closed, and the second valve 22 thereof is open. The vacuum pump 62 is activated and thus suctions and decompresses the inside of the module 11, such that the inside of the module 11 is put in, or brought close to, a vacuum state. At the same time, the heat exchange device 80 causes the heat medium that is to serve as a heat source device to flow through the module 11, thereby supplying thermal energy to increase the temperature of the adsorbent 12 of the module 11. Note that the temperature increasing control performed by the heat exchange device 80 is described hereinafter.

Through the temperature increasing control for the adsorbent 12, the adsorbent 12 is heated to a prescribed temperature (e.g., 80° C.) sufficient for the desorption process, and the carbon dioxide adsorbed to the adsorbent 12 is desorbed. Then, the second valve 22, the third valve 23, and the fourth valve 24 are closed, and the first valve 21 is opened; and the carbon dioxide capture pump 63 is driven, and the desorbed carbon dioxide is stored in the tank (not illustrated) through the carbon dioxide line 103. In present embodiments, each of the processes is controlled such that: 12 modules of the 16 modules 11 perform the adsorption process; and the other 4 modules perform the desorption process.

### Switching Control and Flow Rate Control

Next, descriptions are given of switching control and flow rate control performed for flow passages by the control device 90 in accordance with steps (states) in the adsorption process and the desorption process. In the flow rate control performed by the control device 90, feedback control is performed for the degree of opening of the upstream-side four-way valve 30a and the downstream-side four-way valve 30b so as to adapt to a target time variation profile for the temperature of the adsorbent 12.

The control device 90 may assess the steps for the adsorbent 12 on the basis of the temperature of the adsorbent 12 obtained from the temperature sensor 27, may assess the steps for the adsorbent 12 on the basis of detection values from various sensors such as the pressure sensor 25, or may assess the steps for the adsorbent 12 by means of an elapsed time obtained by, for example, a timer.

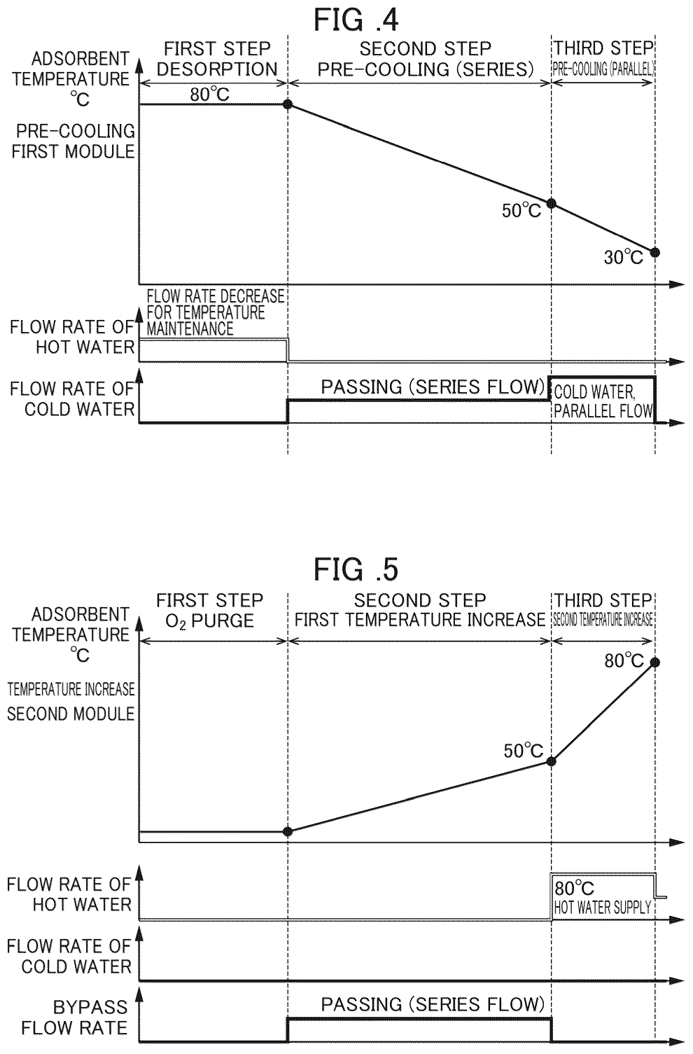

FIG. 4 is a graph indicating the relationship between the temperature of the adsorbent 12 of the first module 11a and the rate of supply of the heat medium. FIG. 5 is a graph indicating the relationship between the temperature of the adsorbent 12 of the second module 11b and the rate of supply of the heat medium. The steps indicated in FIG. 4 correspond to the steps indicated in FIG. 5, and the steps are performed in parallel in the first module 11a and the second module 11b. The first step, the second step, and the third step indicate the order in the graphs. For example, the first step in FIG. 4 does not indicate the initial state of the adsorbent 12 of the carbon dioxide recovery apparatus 1, but indicates a state achieved as a result of transitioning to the desorption process following the temperature increasing control performed temporally before the graph of FIG. 4.

First, descriptions are given of the control in the first step on the first module 11a side indicated in FIG. 4. The desorption process is performed in the first step on the first module 11a side. In the desorption process, the adsorbent 12 has reached 80° C. through the temperature increasing control performed in advance.

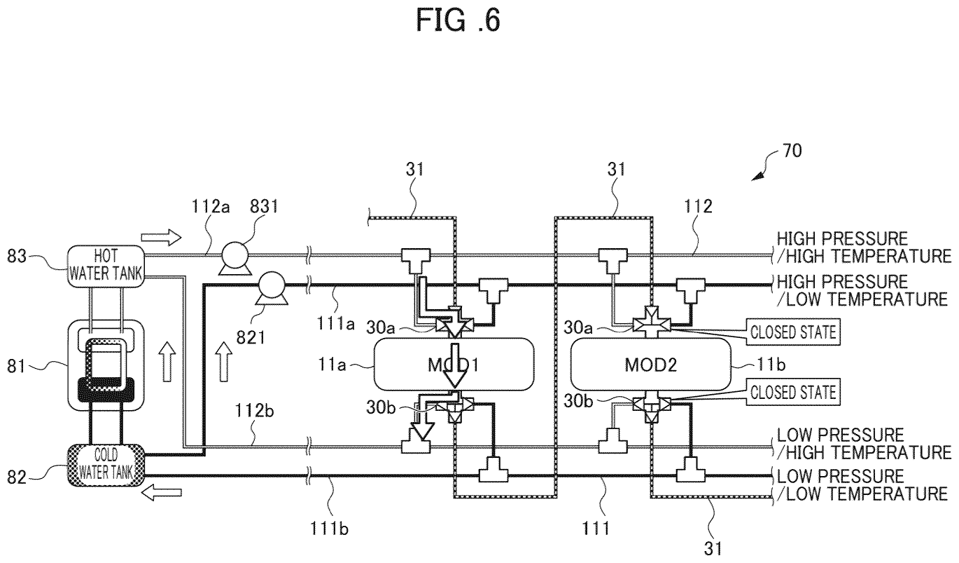

FIG. 6 is a schematic diagram illustrating the connection state of the flow passages of the first module 11a and the second module 11b in the first step. In the first step, as depicted in FIG. 6, the upstream-side four-way valve 30a and the downstream-side four-way valve 30b are controlled so as to be in the hot-water connection state. As a result, the going hot water line 112a and the upstream side of the first module 11a are connected, and the downstream side of the first module 11a and the returning hot water line 112b are connected.

In the first step indicated in the graph of FIG. 4, since the temperature of the adsorbent 12 has already reached 80° C., the rate of supply of hot water may be one at which the temperature of the adsorbent 12 can be maintained. Thus, the control device 90 in the first step performs control for decreasing the degree of opening of the upstream-side four-way valve 30a and the downstream-side four-way valve 30b of the first module 11a so as to achieve a flow rate (e.g., 5 L/min) that is lower than the flow rate (e.g., 10 L/min) in the temperature increasing step preceding the steps illustrated in the graph of FIG. 4.

In the first step on the second module 11b side indicated in FIG. 5, the operation of purging O₂ from within the second module is performed through the suction by the vacuum pump 62. For example, the adsorbent 12 of the second module 11b is at an ordinary temperature of 30° C. or lower. While O₂ is purged, the control device 90 controls the upstream-side four-way valve 30a and the downstream-side four-way valve 30b so as to close all of the passages from the cold water line 111, the hot water line 112, and the bypass line 31 to the second module 11b such that the heat medium does not circulate.

The following describes the second step. As indicated in FIG. 4, pre-cooling (series) starts in the first module 11a in the second step, before which the desorption process has been finished. The wording “series” herein means that cold water passes through the first module 11a and then passes through the second module 11b.

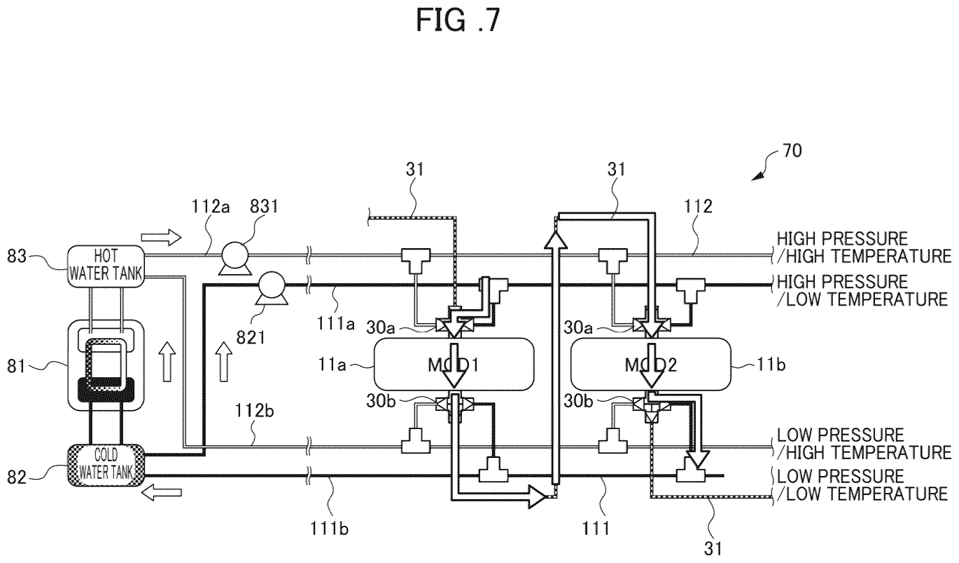

FIG. 7 is a schematic diagram illustrating the connection state of the flow passages of the first module 11a and the second module 11b in the second step. As depicted in FIG. 7, the control device 90 controls and puts the upstream-side four-way valve 30a in the cold-water connection state, and controls and puts the downstream-side four-way valve 30b in the bypass connection state. As a result, the going cold water line 111a and the upstream side of the first module 11a are connected, and the downstream side of the first module 11a and the bypass line 31 are connected.

As indicated in FIG. 5, first temperature increasing control starts in the second module 11b in the second step, before which the O₂ purge has been finished. The first temperature increasing control is performed for the purpose of increasing the temperature of the adsorbent 12 from an ordinary temperature to about 50° C.

As depicted in FIG. 7, the control device 90 in the second step controls and puts the upstream-side four-way valve 30a in the bypass connection state, and controls and puts the downstream-side four-way valve 30b in the cold-water connection state. As a result, the bypass line 31 and the upstream side of the second module 11b are connected, and the downstream side of the second module 11b and the returning cold water line 111b are connected.

In the first module 11a in the second step, the cold water from the going cold water line 111a is introduced to the upstream side of the first module 11a, and the adsorbent 12 of the first module 11a is gradually cooled from 80° C. down to 50° C. The cold water flowing out from the downstream side of the first module 11a, which has received heat from the adsorbent 12 while passing through the first module 11a, has a higher temperature than before being introduced into the first module 11a.

With respect to the second module 11b in the second step, water (bypass water) that has passed through the first module 11a is introduced to the upstream side of the second module 11b through the bypass line 31. The bypass water gradually increases the temperature of the adsorbent 12 of the second module 11b from an ordinary temperature to about 50° C. In the second step, as described above, heat is passed from the first module 11a to the second module 11b.

The pre-cooling in the first module 11a in the second step and the temperature increase in the second module 11b in the second step correspond to intermediate steps before final target temperatures and require a relatively low flow rate. In the second step, accordingly, the control device 90 performs control for achieving a relatively low flow rate (e.g., 5 L/min) by decreasing the degrees of opening of the upstream-side four-way valve 30a and the downstream-side four-way valve 30b of the first module 11a and the upstream-side four-way valve 30a and the downstream-side four-way valve 30b of the second module 11b.

The following describes the third step. As indicated in FIG. 4, pre-cooling (parallel) is performed in the first module 11a in the third step. The wording “parallel” herein means that the heat medium (cold water and hot water) is supplied to the first module 11a and the second module 11b in parallel.

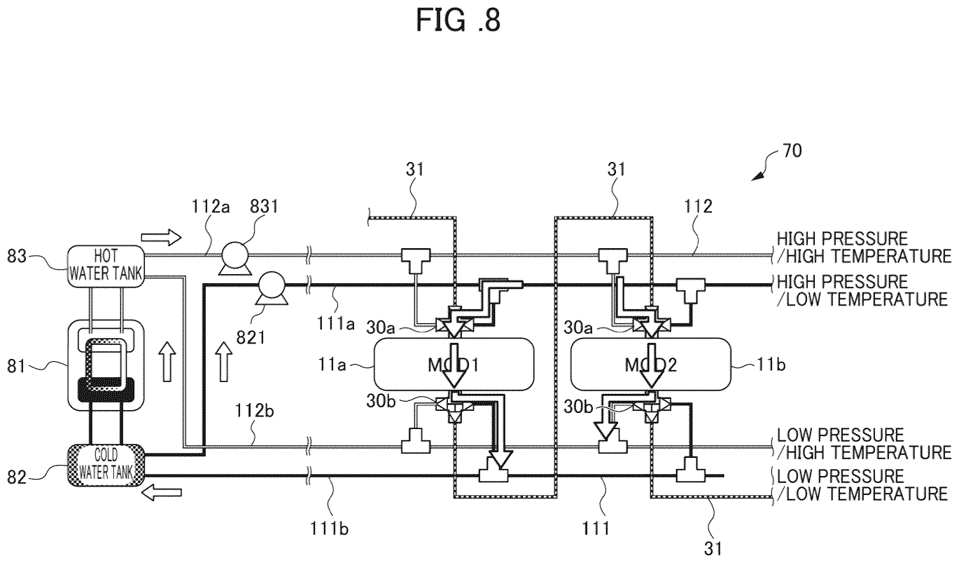

FIG. 8 is a schematic diagram illustrating the connection state of the flow passages of the first module 11a and the second module 11b in the third step. As depicted in FIG. 8, the control device 90 in the third step controls and puts the upstream-side four-way valve 30a and the downstream-side four-way valve 30b of the first module 11a in the cold-water connection state. As a result, the going cold water line 111a and the upstream side of the first module 11a are connected, and the downstream side of the first module 11a and the returning cold water line 111b are connected. The cold water at a low temperature from the going cold water line 111a is introduced into the first module 11a, and the adsorbent 12 of the first module 11a is cooled from 50° C. down to about 30° C.

The pre-cooling (parallel) in the first module 11a in the third step is a process in which the adsorbent 12 of the first module 11a is cooled from 50° C. down to a target temperature (30° C.), and the control device 90 controls the degree of opening of the upstream-side four-way valve 30a and the downstream-side four-way valve 30b of the first module 11a so as to achieve a higher flow rate (e.g., 10 L/min) than in the pre-cooling (series) in the second step.

As indicated in FIG. 5, second temperature increasing control starts in the second module 11b in the third step, before which the first temperature increasing control has been finished. The second temperature increasing control is performed for the purpose of increasing the temperature of the adsorbent 12 from about 50° C. to 80° C., which is a target temperature for performing the desorption process.

As depicted in FIG. 8, the control device 90 in the third step controls and puts the upstream-side four-way valve 30a and the downstream-side four-way valve 30b of the second module 11b in the hot-water connection state. As a result, the going hot water line 112a and the upstream side of the second module 11b are connected, and the downstream side of the second module 11b and the returning hot water line 112b are connected. The hot water at a high temperature from the going hot water line 112a is introduced into the second module 11b, and the temperature of the adsorbent 12 of the second module 11b is gradually increased from 50° C. to 80° C.

The second temperature increasing control in the second module 11b in the third step is a process in which the temperature of the adsorbent 12 of the second module 11b is increased from 50° C. to a target temperature (80° C.), and the control device 90 controls the degree of opening of the upstream-side four-way valve 30a and the downstream-side four-way valve 30b of the second module 11b so as to achieve a higher flow rate (e.g., 10 L/min) than in the first temperature increasing control in the second step.

As described above, the carbon dioxide recovery apparatus 1 according to present embodiments includes: a plurality of modules 11 that each have an adsorbent 12 therein and perform an adsorption process in which a gas containing carbon dioxide is suctioned to the adsorbent 12 such that the adsorbent adsorbs the carbon dioxide and a desorption process in which the carbon dioxide is desorbed from the adsorbent 12 by heating the surroundings of the adsorbent 12 with the surroundings being decompressed; a hot water line (adapted-for-heating heat medium line) 112 for supplying, to each of the plurality of modules 11, a relatively high-temperature hot water (heat medium) so as to heat the adsorbent 12 for performing the desorption process; a cold water line (adapted-for-cooling heat medium line) 111 for supplying a relatively low-temperature heat medium (cold water) so as to cool the adsorbent 12 for performing the adsorption process; a heat source device 81 that is capable of heating hot water flowing through the hot water line 112, and cooling cold water flowing through the cold water line 111; a bypass line 31 that is capable of introducing the heat medium that has passed through a first module 11a, which is one of the plurality of modules 11, into a second module 11b differing from the first module 11a; an upstream-side four-way valve 30a and a downstream-side four-way valve 30b (flow rate adjuster) that are disposed for each of the modules 11, and that are capable of switching between the hot water line 112, the cold water line 111, and the bypass line 31 for a passage through which the heat medium is to be supplied to the module 11, and adjusting the flow rate of the heat medium to pass through the module 11; and a control device 90 that changes, in accordance with the state of the adsorbent 12 by controlling the upstream-side four-way valve 30a and the downstream-side four-way valve 30b, switching control for switching the passage for the heat medium and flow rate control for adjusting the flow rate of the heat medium.

As a result, exhaust heat recovery can be performed between the first module 11a and the second module 11b. An efficient thermal energy exchange can be made between the first module 11a and the second module 11b, and the amount of electric energy required to heat a heat medium such as hot water can be decreased. In addition, the flow rate can be changed in each of the steps in the adsorption process and the desorption process, so that an exact required amount of water can be supplied by selecting a proper flow rate in accordance with the state of the adsorbent 12. Meanwhile, a pressure drop (required lifting height) is proportional to the square of the flow rate, and the workload on the cold water-circulating water pump 821 and the hot water-circulating water pump 831 is proportional to the product of the lifting height and the flow rate. If the degree of opening were not adjusted, a heat medium such as hot water or cold water would always flow at the maximum flow rate. In present embodiments, the flow rate can be decreased in accordance with the steps so that the energy efficiency of the carbon dioxide recovery apparatus 1 can be enhanced by significantly decreasing the pump workload.

In present embodiments, the flow rate adjuster is formed from an upstream-side four-way valve 30a connected to the upstream side of the module 11 and having the hot water line 112, the cold water line 111, and the bypass line 31 connected thereto, and a downstream-side four-way valve 30b connected to the downstream side of the module 11 and having the hot water line 112, the cold water line 111, and the bypass line 31 connected thereto, and by switching internal flow passages of the upstream-side four-way valve 30a and the downstream-side four-way valve 30b, the control device 90 switches the passage for the heat medium to be supplied to the module 11.

As a result, the switching control for the heat medium supplied through the hot water line 112, the cold water line 111, and the bypass line 31 can be performed by means of the upstream-side four-way valve 30a and the downstream-side four-way valve 30b. A flow rate adjustment function does not need to be disposed for each of the hot water line 112, the cold water line 111, and the bypass line 31, so that the features for changing the flow rate of the heat medium supplied to the adsorbent 12 in accordance with the temperature potential can be implemented with the simple configuration.

In present embodiments, the control device 90 performs the flow rate control such that, in comparison with the flow rate in a temperature increasing step of increasing the temperature of the adsorbent 12 to a prescribed temperature in the desorption process by means of hot water supplied from the hot water line 112, the flow rate is low in a maintenance step of maintaining, at the prescribed temperature, the adsorbent 12 that has reached the prescribed temperature as a result of the temperature increase.

Accordingly, in the desorption process, which is performed for the purpose of maintaining the temperature and in which a low flow rate is required, the flow rate of the heat medium supplied to the module 11 can be made lower than in the temperature increasing step, thereby reducing the workload on the hot water-circulating water pump 831.

In present embodiments, the control device 90 performs, after the desorption process is performed, bypass control for cooling the adsorbent 12 of the first module 11a by using cold water supplied from the cold water line 111, and increasing the temperature of the second module 11b by supplying the cold water that has cooled the first module 11a to the second module 11b through the bypass line 31.

As a result, the temperature of the adsorbent 12 of the second module 11b can be increased by cold water having heat received when the adsorbent 12 of the first module 11a was cooled. The temperature can be increased by means of exhaust heat recovery without providing a heat supply from outside, so that the energy efficiency can be further enhanced.

In present embodiments, the control device 90 performs, after performing the bypass control, control for making the flow rate of cold water supplied from the cold water line 111 to the first module 11a higher than in the bypass control.

In the bypass control, as a result, bypass water can be supplied from the first module 11a to the second module 11b at a flow rate required for the second module 11b, while suppressing the workload on the cold water-circulating water pump 821. After the bypass control is performed, the flow rate of the cold water is high so that the temperature of the adsorbent 12 of the first module 11a can be immediately increased to a prescribed temperature.

In present embodiments, after performing the bypass control, the control device 90 closes the passage from the bypass line 31 to the second module 11b, and supplies the heat medium from the hot water line 112 to the second module 11b at a flow rate that is higher than the flow rate at which the heat medium was supplied to the second module 11b in the bypass control. After the bypass control is performed, hot water at a high temperature and a high flow rate is supplied to the second module 11b so that the adsorbent 12 of the second module 11b can be immediately cooled down to an ordinary temperature.

Although embodiments of the present invention have been described so far, the present invention is not limited to the embodiments described above. The effects described with reference to the above-noted embodiments are merely a list of preferable effects, and the effects of the present invention are not limited to those described with reference to the embodiments.

### Explanation of Reference Numerals

1: Carbon dioxide recovery apparatus
11: Module
11a: First module
11b: Second module
12: Adsorbent
30a: Upstream-side four-way valve
30b: Downstream-side four-way valve
31: Bypass line
81: Heat source device
90: Control device
111: Cold water line
111a: Going cold water line
111b: Returning cold water line
112: Hot water line
112a: Going hot water line
112b: Returning hot water line

What is claimed is:

1. A carbon dioxide recovery apparatus comprising:
a plurality of modules that each have an adsorbent therein and perform an adsorption process in which a gas containing carbon dioxide is suctioned to the adsorbent such that the adsorbent adsorbs the carbon dioxide and a desorption process in which the carbon dioxide is desorbed from the adsorbent by heating surroundings of the adsorbent with the surroundings being decompressed;
an adapted-for-heating heat medium line for supplying, to each of the plurality of modules, a relatively high-temperature heat medium so as to heat the adsorbent for performing the desorption process;
an adapted-for-cooling heat medium line for supplying, to each of the plurality of modules, a relatively low-temperature heat medium so as to cool the adsorbent for performing the adsorption process;
a heat source device that is capable of heating the heat medium flowing through the adapted-for-heating heat medium line, and cooling the heat medium flowing through the adapted-for-cooling heat medium line;
a bypass line that is capable of introducing the heat medium that has passed through a first module, which is one of the plurality of modules, into a second module differing from the first module;
a flow rate adjuster that is disposed for each of the modules, and that is capable of switching between the adapted-for-heating heat medium line, the adapted-for-cooling heat medium line, and the bypass line for a passage through which the heat medium is to be supplied to the module, and adjusting a flow rate of the heat medium to pass through the module; and
a control device that changes, in accordance with a state of the adsorbent by controlling the flow rate adjuster, switching control for switching the passage for the heat medium and flow rate control for adjusting the flow rate of the heat medium.

2. The carbon dioxide recovery apparatus according to claim 1, wherein
the flow rate adjuster is formed from an upstream-side four-way valve connected to an upstream side of the module and having the adapted-for-heating heat medium line, the adapted-for-cooling heat medium line, and the bypass line connected thereto, and
a downstream-side four-way valve connected to a downstream side of the module and having the adapted-for-heating heat medium line, the adapted-for-cooling heat medium line, and the bypass line connected thereto, and
by switching internal flow passages of the upstream-side four-way valve and the downstream-side four-way valve, the control device switches the passage for the heat medium to be supplied to the module.

3. The carbon dioxide recovery apparatus according to claim 1, wherein the control device performs the flow rate control such that, in comparison with the flow rate in a temperature increasing step of increasing a temperature of the adsorbent to a prescribed temperature in the desorption process by means of the heat medium supplied from the adapted-for-heating heat medium line, the flow rate is low in a maintenance step of maintaining, at the prescribed temperature, the adsorbent that has reached the prescribed temperature as a result of the temperature increase.

4. The carbon dioxide recovery apparatus according to claim 1, wherein the control device after the desorption process is performed, performs bypass control for cooling the adsorbent of the first module by using the heat medium supplied from the adapted-for-cooling heat medium line, and increasing a temperature of the second module by supplying the heat medium that has cooled the first module to the second module through the bypass line.

5. The carbon dioxide recovery apparatus according to claim 4, wherein the control device after performing the bypass control, performs control for making the flow rate of the heat medium supplied from the adapted-for-cooling heat medium line to the first module higher than in the bypass control.

6. The carbon dioxide recovery apparatus according to claim 4, wherein the control device after performing the bypass control, closes a passage from the bypass line to the second module, and supplies the heat medium from the adapted-for-heating heat medium line to the second module at a flow rate that is higher than the flow rate at which the heat medium was supplied to the second module in the bypass control.
